(19) United States
(12) Patent Application Publication
(10) Pub. No.: US 2005/0281202 A1
(43) Pub. Date: Dec. 22, 2005

(54) Monitoring instructions queueing messages

(75) Inventors: Ronald A. Rocheleau, Hopkinton, MA (US); Richard D. Muratori, Stow, MA (US)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/874,959

(22) Filed: Jun. 22, 2004

(51) Int. Cl. G01R 31/08; G08C 15/00; H04L 12/26; G06F 11/00; H04J 3/14; H04J 1/16; H04L 1/00; H04L 12/56; H04L 12/28

(52) U.S. Cl. 370/241; 370/412

(57) ABSTRACT

Provided are a method, system, and program for monitoring instructions queuing messages. Execution of an operation to add a message to a queue is monitored. Debug information for the put operation indicating a program counter of the instruction and a message address of the message in the queue are accessed. Monitor data is generated for the operation including the accessed debug information and the message content at the message address in the debug information.

### BACKGROUND

Systems in a network environment communicate information in packets that encapsulate the information according to network communication protocols. Packets transmitted from one node to another node may be transmitted through one or more intervening routers that route the packets throughout the network or between networks. The router typically includes one or more network processors to process the packets. The network processor stores packets in a memory device, such as a Static Dynamic Random Access Memory (SDRAM) and stores packet management information, such as message queues in a Static Random Access Memory (SRAM). The network processor may include a plurality of packet engines, also known as microengines, each packet engine having code to perform a particular packet processing operation.

A packet engine executes a put operation (which may comprise one or more processor instructions) to enqueue a message onto a message queue that is accessed by a get operation (which may comprise one or more processor instructions) executed by another packet engine. The get operation subsequently accesses the message from the queue to consume and process.

A developer writing microcode for the packet engines may use an integrated development tool to debug the code. The developer may create one or more source files that when compiled or assembled produce one or more list files. The developer may then assign each list file to a different packet engine. A linker converts the list files to executable microcode that is loaded by the microcode loader into a packet engine. The developer may use a debugger function within an integrated development environment (IDE) tool to observe the list file code corresponding to the microcode being executed by the packet engines. An example of an IDE tool used to develop code for network processor packet engines is described in the publication “Intel® IXP2400/IXP2800 Network Processor Development Tools User's Guide”, order no. 278733-007 (Copyright Intel Corporation, July 2003)

During debugging, the developer may desire to review the queued messages. While monitoring execution of the code, the debugger program may dump the contents of the message queues into a flat file of unformatted data. The developer can view this data dump to attempt to track the status of messages in the queue during processing. However, the user may have difficulty determining the flow of messages from the data dump, which may include messages from many different threads.

### BRIEF DESCRIPTION OF THE DRAWINGS

FIG. 1 illustrates a network processor.

FIG. 2 illustrates a developer system.

FIGS. 3 and 4 illustrate components within a development tool.

FIGS. 5, 6, and 7 illustrate information and data on instructions that queue messages.

FIGS. 8, 9, 10, 11, and 12 illustrate operations performed by a debugger to provide information on instructions related to queuing messages.

FIG. 13 is a diagram of a network processor.

FIG. 14 is a diagram of a network device.

### DETAILED DESCRIPTION

In the following description, reference is made to the accompanying drawings which form a part hereof and which illustrate several embodiments. It is understood that other embodiments may be utilized and structural and operational changes may be made without departing from the scope of the embodiments.

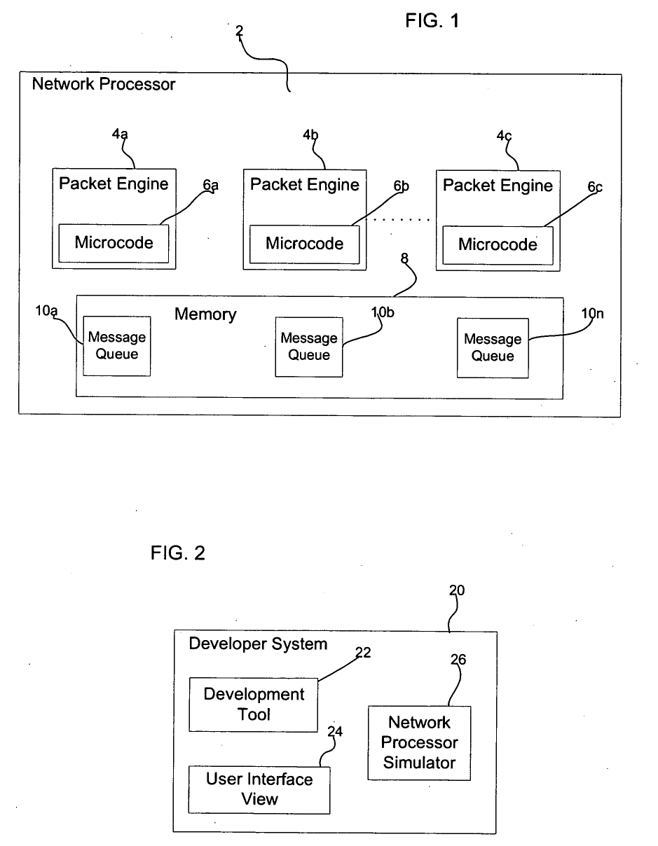

A network processor comprises any device that executes programs to handle packets in a data network, such as processors on router line cards, network access equipment and packet forwarding devices. FIG. 1 illustrates one example of a network processor 2 including packet engines 4a, 4b . . . 4n comprising high speed processors specialized for packet processing. The packet engines 4a, 4b . . . 4n may comprise any programmable engine or processor for processing packets, such as a microengine, etc. The packet engines 4a, 4b . . . 4n may execute microcode 6a, 6b . . . 6n, such as microblocks, to process packets, where the microcode 6a, 6b . . . 6n comprises fast-path packet processing logic executed by the packet engines 4a, 4b . . . 4n. The packet engines 4a, 4b . . . 4n may instantiate multiple threads to execute different parts of the microcode 6a, 6b . . . 6n. The network processor 2 may include an on-board memory device 8 to store packets and other packet processing related information that is accessible to the packet engines 4a, 4b . . . 4n. In FIG. 1, the memory 8 maintains message queues 10a, 10b . . . 10n that include messages being transferred from threads executed by one packet engine 4a, 4b . . . 4n to another thread executed by another packet engine 4a, 4b . . . 4n. A message may comprise a packet, a fragment of a packet or data being communication between packet engines 4a, 4b . . . 4n that may or may not be related to packet data. In certain embodiments, the message queues 10a, 10b . . . 10n may be implemented in next neighbor registers, which comprises memory one packet engine makes available to an adjacent packet engine.

FIG. 2 illustrates a developer computer system 20 that a programmer or developer creating microcode 4a, 4b . . . 4n may use, including a software development tool 22 to use to create, test and debug microcode and a user interface view 24 generated by the development tool 22 to enable the user to interface with the debugger program. A network processor simulator 26 may execute code being developed and tested using the development tool 22 and simulate the operation of one or more packet engines 4a, 4b . . . 4n, and the threads executing in each packet engine, on one or more network processors 26 executing the microcode in development. The developer may configure the network processor simulator 26 to set the parameters of the simulation environment, such as the clock frequencies of the packet engines, settings for memory devices 8 used by the network processor 6, such as clock frequency and byte size, bus settings, etc. The developer may further configure packet simulation parameters in the simulation environment that the simulated network processor processes using the microcode subject to the debugging operations.

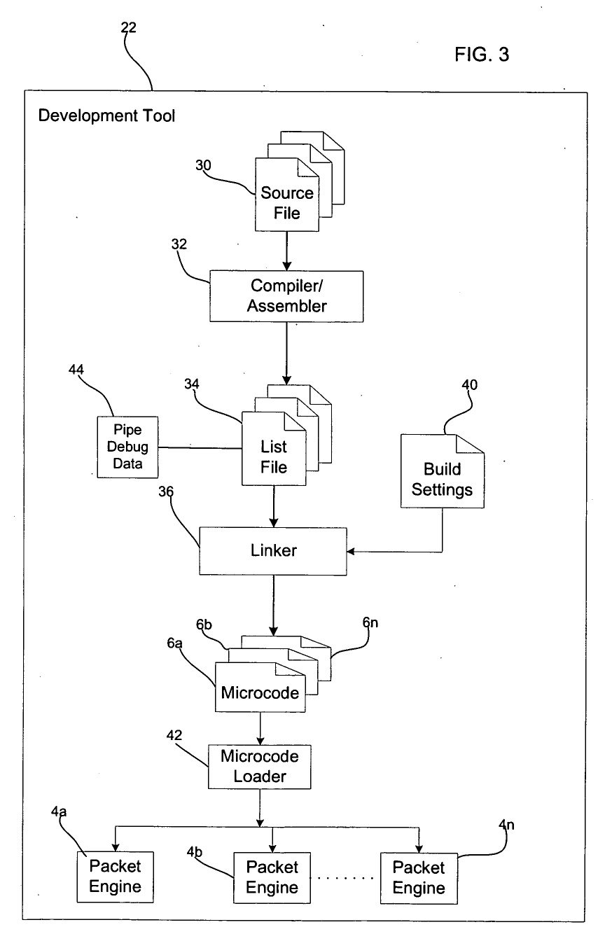

FIG. 3 illustrates programs and elements in the development tool 22 to perform microcode development related operations. Source files 30 include the source code for the microcode being developed. The source files 30 may be created in assembly language or any C language compiler. The programs to create the source files 30 may be incorporated into the development tool 22. A compiler/assembler 32 program translates the source files 30 into list files 34. The compiled or assembled list files 34 differ from the source code in that symbols may be replaced with actual values, instructions may be reordered for optimization, and the names of local registers are included. The list files 34 may be provided to a linker 36 program, which then translates the list files 34 into executable microcode 38 object files. In certain embodiments, the user may create build settings 40 to associate list files 34 with packet engines 4a, 4b . . . 4n, such that one list file 34 is associated with one packet engine 4a, 4b . . . 4n, so that the assigned packet engine 4a, 4b . . . 4n executes the microcode 6a, 6b . . . 6n generated from the list file indicated in the assignment. The microcode 6a, 6b . . . 6n generated from the list files 34 are loaded into the associated packet engines 4a, 4b . . . 4n and executed by threads in the packet engine 4a, 4b . . . 4n. A microcode loader 42 may load the generated microcode 6a, 6b . . . 6n into the appropriate packet engine 4a, 4b . . . 4n or simulated packet engine if the network processor simulator 26 is used. In this way, the build settings 40 are used to control how list files 34 and their corresponding microcode are assigned to packet engines 4a, 4b . . . 4n.

Pipe debug data 44 is associated with the list files 34, including information on put and get operations that add and access, respectively, messages from the queues 10a, 10b . . . 10n. The pipe debug data 44 may include the program counter of the put or get operation, memory address of the message being processed by the put or get operation, etc. This pipe debug data 44 may be coded by the developer who manually codes the message queue 10a, 10b . . . 10n operations by the packet engines 4a, 4b . . . 4n. Alternatively, the pipe debug data 44 may be automatically generated by the compiler/assembler 32.

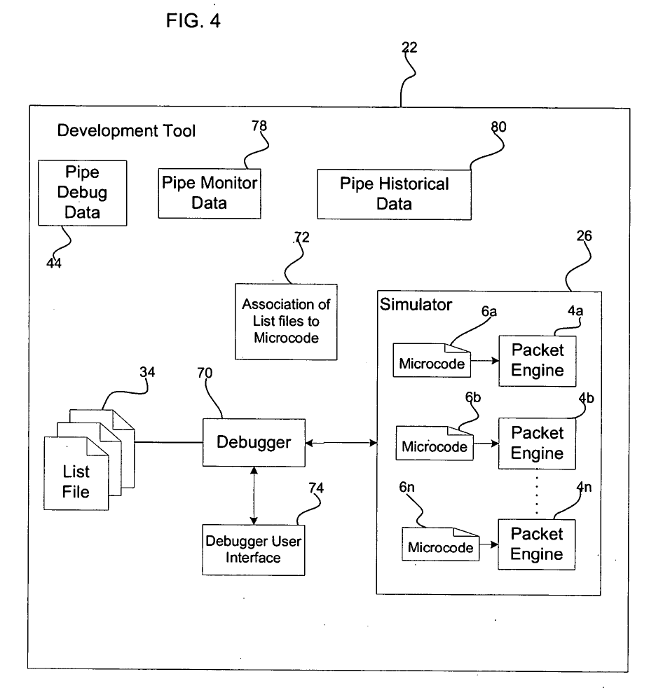

FIG. 4 illustrates components implemented in the development tool 22 to perform debugging related operations. The simulator 26 simulates packet engines 4a, 4b . . . 4n that launch threads to execute the microcode 6a, 6b . . . 6n generated from the list files 34. A debugger 70 is the program that enables a user to perform debugging related operations. The debugger 70 maintains an association 72 of list files 34 to the executable microcode 6a, 6b . . . 6n. This debugger 70 uses this association 72 to generate in a debugger user interface 74 the code of the list files 34 corresponding to the microcode 6a, 6b . . . 6n being executed by simulated or real packet engines 4a, 4b . . . 4n. Further, from the list files 34, the debugger 70 may also determine the corresponding source file 30 code so that the source code corresponding to an instruction monitored by the debugger may be generated, e.g., displayed, in the user interface 74

The debugger 70 further maintains the pipe debug data 44 including information on put and get operations and pipe monitor data 78 including information on put operations that have added a message to a message queue 10a, 10b . . . 10n that has not yet been accessed by a get operation. The packet engine 4a, 4b . . . 4n executing the put operation may be different than the packet engine 4a, 4b . . . 4n executing the get operation. The debugger 70 further maintains pipe historical data 80 including information on put and get operations that have processed a message in one queue.

FIG. 5 illustrates an entry in the pipe debug data 44, where there may be an entry for each put and get operation included in the microcode 6a, 6b . . . 6n being executed and monitored by the debugger 70. Each pipe debug data entry 100 may include:
program counter 102: a counter identifying a particular instruction in the microcode 6a, 6b . . . 6n. The debugger 70 includes a mapping (not shown) to determine the source file 30 code corresponding to a program counter of an executable instruction in the microcode 6a, 6b . . . 6n and list files 34.
Put/Get 104: indicates whether the instruction for which the information is maintained is a put or get operation.
Packet engine 106: identifies the packet engine 4a, 4b . . . 4n executing the microcode 6a, 6b . . . 6n including the put or get operation identified by the program counter 102.
Memory type 108: indicates the type of memory including the message processed by the put or get operation, such as registers.
Message address 110: the address of the message in one message queue 10a, 10b . . . 10n. The address may comprise a static address of the message in the queue 10a, 10b . . . 10n if the address does not change as further messages are added to the queue, such as the case with a circular buffer. Alternatively, the address may comprise a pointer to a head of the queue 10a, 10b . . . 10n. In such embodiments, the debugger 70 could determine the offset of the message in the queue by maintaining a counter indicating a number of messages in the queue and the byte length of the queued messages.
Message format 112: indicates a data format of the message, such as the bytes in the message and their formats, e.g., character, integer, etc. The message format 112 enables the debugger 70 to generate a user intelligible format of the message content.

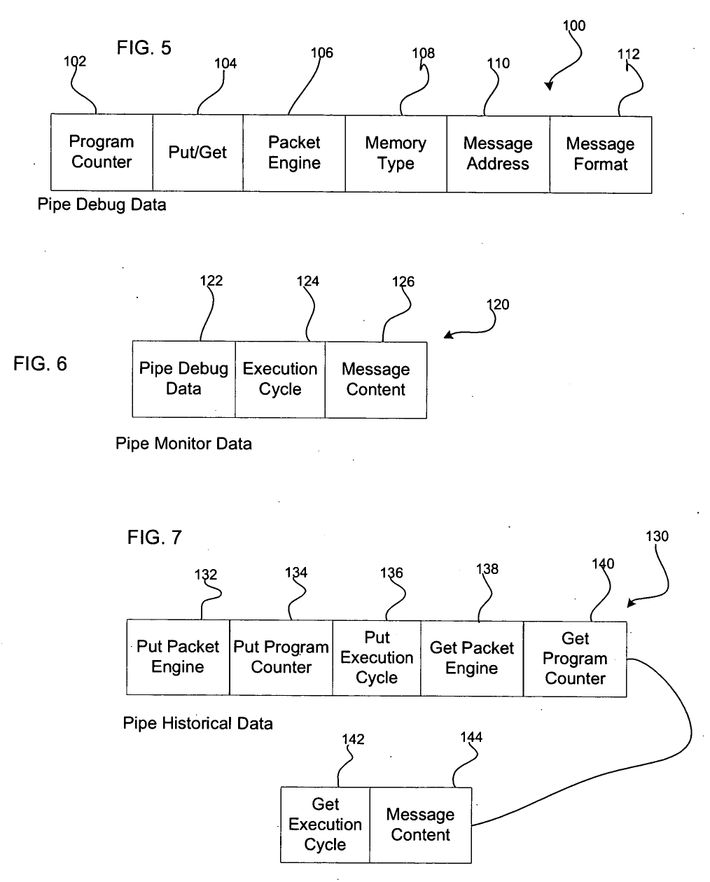

FIG. 6 illustrates information maintained in the pipe monitor data 78 for a put operation that added a message to one queue 10a, 10b . . . 10n that has not yet been consumed by a corresponding get operation executed by a different (or same) packet engine 4a, 4b . . . 4n. The pipe monitor data 120 for one put operation may include:
Pipe debug data 122: includes some or all of the fields in the pipe debug data entry 100 for the put operation, such as the program counter 102, packet engine 106, memory address 110, etc.
Execution cycle 124: indicates the cycle in the packet engine 4a, 4b . . . 4n on which the put operation was executed.
Message content 126: provides the message content of the message the put operation added to one message queue 10a, 10b . . . 10n. In certain embodiments, the message content 126 is formatted according to the message format 112 to place the content in a user understandable format.

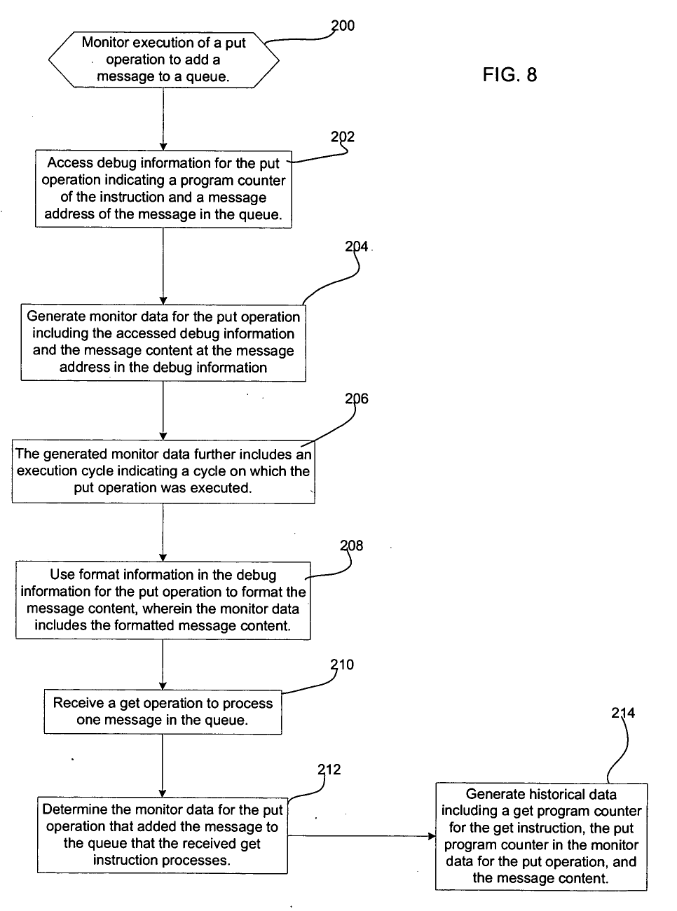

FIG. 7 illustrates pipe historical data 130 maintaining information on an executed put and get operation pair that has processed a message in one message queue 10a, 10b . . . 10n, and includes:
Put packet engine 132: identifies the packet engine 4a, 4b . . . 4n that executed the put operation that added the message to the queue 10a, 10b . . . 10n.

Put program counter 134: the program counter of the put operation in the microcode 6a, 6b . . . 6n or list file 34.

Put execution cycle 136: indicates the cycle in which the packet engine 4a, 4b. 4n executed the put operation.

Get packet engine 138: identifies the packet engine 4a, 4b . . . 4n that executed the get operation that pulled the message out of the queue 10a, 10b . . . 10n to process.
Get program counter 140: the program counter of the get operation in the microcode 6a, 6b . . . 6n or list file 34 that accessed the message to process.
Get execution cycle 142: indicates the cycle in which the packet engine 4a, 4b . . . 4n executed the get operation.
Message content 144: comprises the message content, which may be formatted according to the message format information 112 in the pipe debug data 100.

FIG. 8 illustrates operations performed by the debugger 70 to monitor the execution of put and get operations and gather the pipe monitor data 78 and pipe historical data 80. The debugger 70 monitors (at block 200) execution of a put operation to add a message to a queue, e.g., 10a, 10b . . . 10n. In certain embodiments, the message added to the queue may comprise a packet being processed by packet engines. For instance, one packet engine 4a, 4b . . . 4n may execute a put operation to add the message to a queue and another packet engine 4a, 4b . . . 4n executes a get operation to take the message from the message queue 10a, 10b . . . 10n to process. The debugger 70 accesses (at block 202) debug information, such as the pipe debug data 100, for the put operation indicating a program counter, e.g., 102, of the instruction and a message address, e.g., 110 of the message in the queue, e.g., 10a, 10b . . . 10n. As discussed, this debug data 100 may be coded by the developer for each put and get operation in the source code 30. In certain embodiments, monitoring the execution of the put operation may comprise determining a program counter of the put operation and then searching for debug information, e.g., pipe debug data 100 (FIG. 5), having a program counter, e.g., 102, matching the determined program counter of the put operation. The accessed debug information may include the program counter matching the put operation program counter.

The debugger 70 then generates (at block 204) monitor data, e.g., 120 (FIG. 6) for the put operation including the accessed debug information, e.g., 122, and the message content, e.g., 126, at the message address, e.g., 110, in the debug information, e.g., 100 (FIG. 5). In certain embodiments, the generated monitor data, e.g., 120, may include (at block 206) an execution cycle, e.g., 124, indicating a cycle on which the put operation was executed. The debugger 70 may use (at block 208) message format information, e.g., 112, in the debug information, e.g., pipe debug data 100, for the put operation to format the message content. In this way, the monitor data, e.g., pipe monitor data 120, includes the formatted message content, e.g., 126.

Upon receiving (at block 210) a get operation to process one message in the queue, e.g., 10a, 10b . . . 10n, the debugger 70 determines (at block 212) the monitor data, e.g., 120, for the put operation that added the message to the queue that the received get operation processes. The debugger 70 may determine the monitor data 120 for the put operation by determining the monitor data 120 having a message address, e.g., 110, matching the message address that the get operation accesses in the queue 10a, 10b . . . 10n. The debugger 70 generates (at block 214) historical data, e.g., 130 (FIG. 7) including a get program counter, e.g., 140, for the get operation, the put program counter, e.g., 130, in the monitor data, e.g., 130, for the put operation, and the message content, e.g., 144. The message content 144 in the historical data may come from the accessed monitor data 120 or from the queue 10a, 10b . . . 10n.

In certain embodiments, the debugger 70 may generate the historical data 130 by determining debug information, e.g., debug data 100, for the received get operation having a program counter, e.g., 102, matching the program counter of the get operation. The get program counter is determined from the debug information. Yet further, the historical data, e.g., 130, may indicate a first processor, e.g., put packet engine 132, executing the put operation and a second processor, e.g., get packet engine 138, executing the get operation.

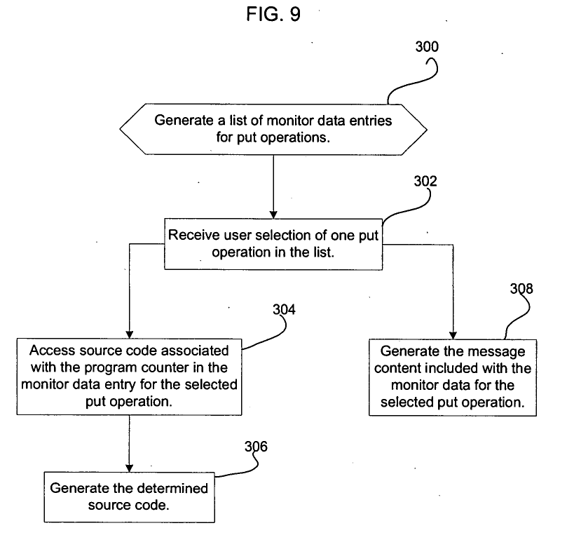

FIG. 9 illustrates operations the debugger 70 performs to make pipe monitor data 78 available to the developer. The debugger 70 generates (at block 300) a list of monitor data entries 120 in the pipe monitor data 78 for put operations. Upon receiving (at block 302) user selection of one put operation in the generated list, the debugger 70 may generate either the source code corresponding to the selected put operation or the message content that the put operation added to the queue 10a, 10b . . . 10n. To generate source code corresponding to the put operation, the debugger 70 accesses (at block 304) the source code associated with the program counter, e.g., 102, in the monitor data entry 120 for the selected put operation and generates (at block 306) the source code in the debugger user interface 74. Alternatively, the debugger 70 may generate (at block 308) the message content, e.g., 126, included with the monitor data, e.g., 120, for the selected put operation in the debugger user interface 74. In certain embodiments, the debugger 70 may generate the source file 30 code corresponding to the selected put operation in response to the user selecting, e.g., clicking with a mouse, the program counter of the displayed monitor data entry. The debugger 70 may generate the message content, e.g., 144, that the put operation placed in the memory address 110 of the queue 10a, 10b . . . 10n in response to the developer selecting the memory address in one displayed monitor data entry.

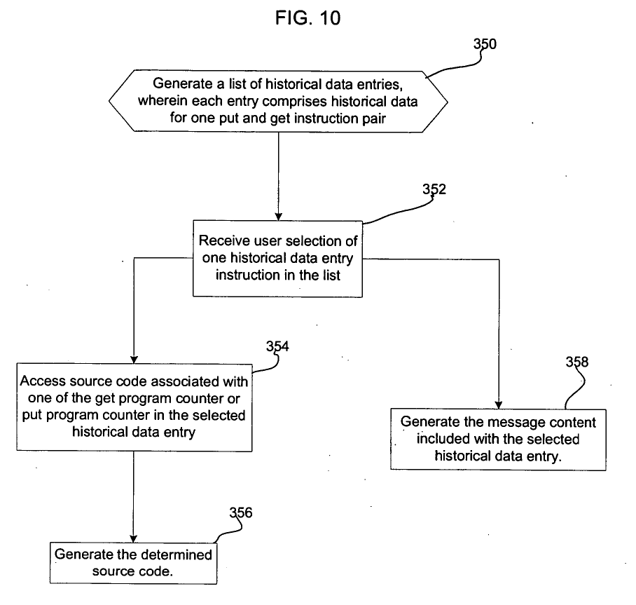

FIG. 10 illustrates operations the debugger 70 performs to make pipe historical data 80 available to the developer. The debugger 70 generates (at block 350) a list for the historical data 80 entries in the user interface 74, wherein each entry comprises historical data for one put and get operation pair processing a queued message. In response to receiving (at block 352) user selection of one historical data entry 130 instruction in the list, the debugger 70 may generate either the source code corresponding to a selected put or get operation in the historical data or the message content that the put and get operations process. To generate source code corresponding to the put or get operation, the debugger 70 accesses (at block 354) the source code associated with one of the get program counter or put program counter in the selected historical data entry 130 (FIG. 7) and generates (at block 356) the accessed source code in the debugger user interface 74. Alternatively, the debugger 70 may generate (at block 358) the message content, e.g., 144, included with the historical data, e.g., 130, for the put or get operation in the debugger user interface 74. In certain embodiments, the debugger 70 may generate the source code in response to the user selecting, e.g., clicking with a mouse, the program counter of the put or get operation in the displayed monitor data entry. The debugger 70 may generate the message content, e.g., 144, that the put operation placed in the memory address 110 of the queue 10a, 10b . . . 10n in response to the developer selecting the memory address in one displayed historical data entry.

Thus, with the embodiments of FIGS. 9 and 10, the developer may obtain information on put and get operations by selecting pipe monitor data 120 or pipe historical data 80 for put and/or get operations.

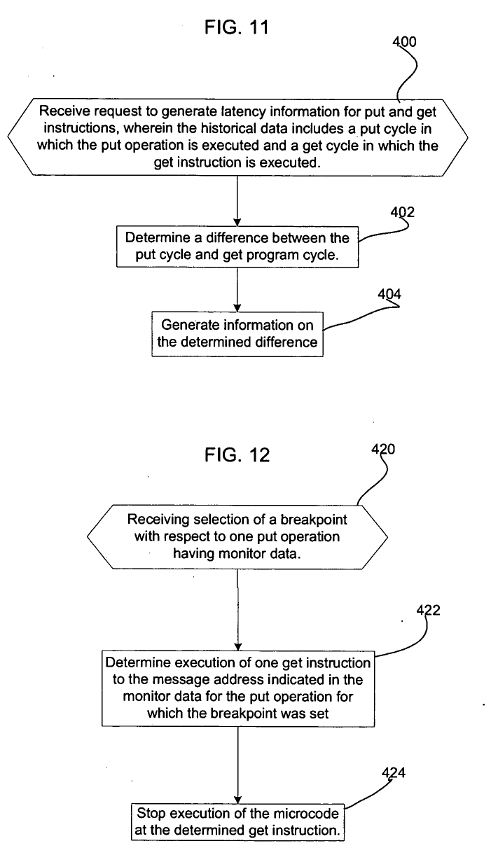

FIG. 11 illustrates operations the debugger 70 performs to provide the developer with information on the latency of put and get operations, which is the time elapsed from when the put operation was executed to add a message to the queue 10a, 10b . . . 10n and the get operation was executed to process and remove the message from the queue 10a, 10b . . . 10n. To provide latency information, the put execution cycle 136 and get execution cycle 142 information in the historical data 130 are used. This information may be added to the historical data 130 when the debugger 70 receives notification of the execution of the put and get operations from the simulator 26. The put execution cycle 124 is added to the pipe monitor data 120 when receiving notification of the execution of the put operation. Upon receiving (at block 400) a request to generate latency information for put and get operations, the debugger 70 determines (at block 402) a difference between the put cycle, e.g., 136, and get cycle, e.g., 142, and generates (at block 404) information on the difference in the user interface 74. In this way, the developer may determine the latency of the messages in the queues 10a, 10b . . . 10n to determine which message processing needs to be modified to improve performance.

FIG. 12 illustrates operations to utilize breakpoints with the monitor data 78. Upon receiving (at block 420) selection of a breakpoint with respect to one put operation having monitor data, e.g., 120, the debugger 70 determines (at block 422) execution of one get operation to the message address, e.g., 110, queued by a put operation for which a breakpoint was set. The debugger 70 upon receiving notification of execution of a get operation checks whether the get operation is accessing a memory address in the queue for which a breakpoint was set with respect to the corresponding put operation. The debugger 70 stops (at block 424) execution of the microcode at the determined get operation. Through the user interface 74, the debugger 70 may notify the developer of the breakpoint being satisfied to allow the developer to perform debugging related operations.

The described embodiments provide techniques for maintaining and using information on put and get operations to enable a debugger to present to a developer detailed information on the put and get operations and the message content being processed. Moreover, by storing the message content in the historical data, the historical data maintains the state of the queue at different points in time to allow the developer to review the message content that was processed by different put and get operations.

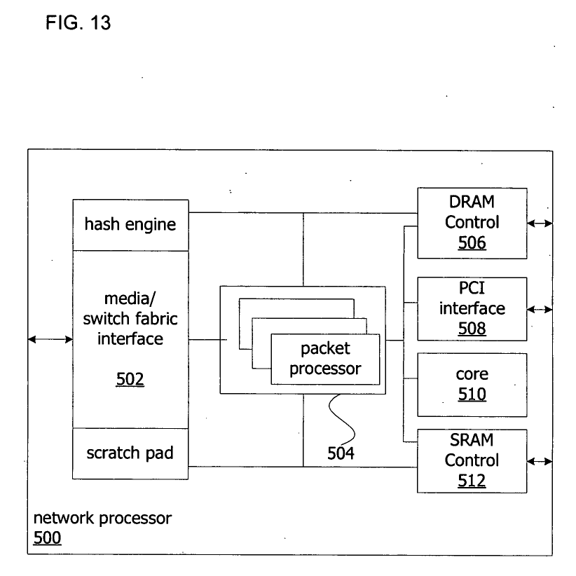

FIG. 13 illustrates an example of a network processor 500. The network processor 500 shown is an Intel® Internet exchange network Processor (IXP). Other network processors feature different designs. The network processor 500 shown features a collection of packet engines 504, also known as microengines programmable engines, etc. The packet engines 504 may be Reduced Instruction Set Computing (RISC) processors tailored for packet processing. For example, the packet engines 504 may not include floating point instructions or instructions for integer multiplication or division commonly provided by general purpose processors. The network processor 500 components may be implemented on a single integrated circuit die.

An individual packet engine 504 may offer multiple threads. For example, the multi-threading capability of the packet engines 504 may be supported by hardware that reserves different registers for different threads and can quickly swap thread contexts. In addition to accessing shared memory, a packet engine may also feature local memory and a content addressable memory (CAM). The packet engines 504 may communicate with neighboring processors 504, for example, using neighbor registers wired to the adjacent engine(s) or via shared memory.

The network processor 500 also includes a core processor 510 (e.g., a StrongARM® XScale®) that is often programmed to perform “control plane” tasks involved in network operations. (StrongARM and XScale are registered trademarks of Intel Corporation). The core processor 510, however, may also handle “data plane” tasks and may provide additional packet processing threads.

As shown, the network processor 500 also features interfaces 502 that can carry packets between the processor 500 and other network components. For example, the processor 500 can feature a switch fabric interface 502 (e.g., a CSIX interface) that enables the processor 500 to transmit a packet to other processor(s) or circuitry connected to the fabric. The processor 500 can also feature an interface 502 (e.g., a System Packet Interface Level 4 (SPI-4) interface) that enables to the processor 500 to communicate with physical layer (PHY) and/or link layer devices. The processor 500 also includes an interface 508 (e.g., a Peripheral Component Interconnect (PCI) bus interface) for communicating, for example, with a host. As shown, the processor 500 also includes other components shared by the engines such as memory controllers 506, 512, a hash engine, and scratch pad memory.

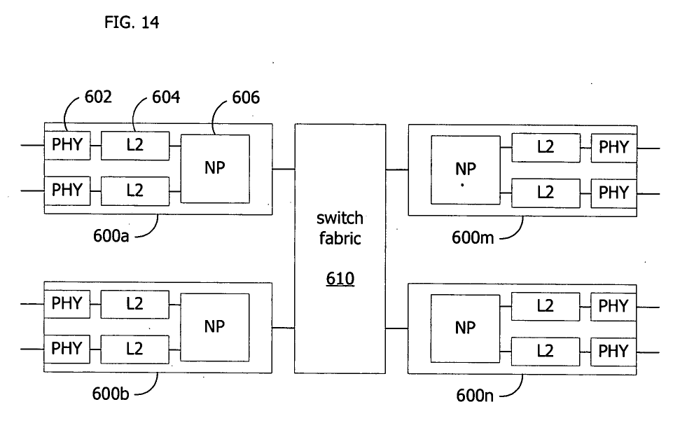

FIG. 14 depicts a network device incorporating techniques described above. As shown, the device features a collection of line cards 600 (“blades”) interconnected by a switch fabric 610 (e.g., a crossbar or shared memory switch fabric). The switch fabric, for example, may conform to CSIX or other fabric technologies such as HyperTransport, Infiniband, PCI-X, Packet-Over-Synchronous Optical Network (SONET), RapidIO, and Utopia. CSIX is described in the publication “CSIX-L1: Common Switch Interface Specification-L1”, Version 1.0, published August, 2000 by CSIX; HyperTransport is described in the publication “HyperTransport I/O Link Specification”, Rev. 1.03, published by the HyperTransport Tech. Consort., October, 2001; InfiniBand is described in the publication “InfiniBand Architecture, Specification Volume 1”, Release 1.1, published by the InfiniBand trade association, November 2002; PCI-X is described in the publication PCI-X 2.0 Specification by PCI-SIG; SONET is described in the publication “Synchronous Optical Network (SONET)—Basic Description including Multiplex Structure, Rates and Formats,” document no. T1X1.5 by ANSI (January 2001); RapidIO is described in the publication “RapidIO Interconnect Specification”, Rev. 1.2, published by RapidIO Trade Ass'n, June 2002; and Utopia is described in the publication “UTOPIA: Specification Level 1, Version 2.01”, published by the ATM Forum Tech. Comm., March, 1994.

Individual line cards (e.g., 600a) include one or more physical layer (PHY) devices 602 (e.g., optic, wire, and wireless PHYs) that handle communication over network connections. The PHYs translate between the physical signals carried by different network mediums and the bits (e.g., “0”-s and “1”-s) used by digital systems. The line cards 600 may also include framer devices (e.g., Ethernet, Synchronous Optic Network (SONET), High-Level Data Link (HDLC) framers or other “layer 2” devices) 604 that can perform operations on frames such as error detection and/or correction. The line cards 600 shown also include one or more network processors 606 or integrated circuits (e.g., ASICs) that perform packet processing operations for packets received via the PHY(s) 600 and direct the packets, via the switch fabric 610, to a line card providing the selected egress interface. Potentially, the network processor(s) 606 may perform “layer 2” duties instead of the framer devices 604 and the network processor operations described herein.

While FIGS. 13 and 14 described a network processor and a device incorporating network processors, the techniques may be implemented in other hardware, firmware, and/or software. For example, the techniques may be implemented in integrated circuits (e.g., Application Specific Integrated Circuits (ASICs), Gate Arrays, and so forth). Additionally, the techniques may be applied to a wide variety of networking protocols at different levels in a protocol stack and in a wide variety of network devices (e.g., a router, switch, bridge, hub, traffic generator, and so forth).

### Additional Embodiment Details

The described embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the embodiments, and that the article of manufacture may comprise any information bearing medium known in the art.

The described operations may be performed by circuitry, where “circuitry” refers to either hardware or software or a combination thereof. The circuitry for performing the operations of the described embodiments may comprise a hardware device, such as an integrated circuit chip, Programmable Gate Array (PGA), Application Specific Integrated Circuit (ASIC), etc. The circuitry may also comprise a processor component, such as an integrated circuit, and code in a computer readable medium, such as memory, wherein the code is executed by the processor to perform the operations of the described embodiments.

In certain embodiments, the debugger monitored the execution of put and get operations by one or more packet engines, e.g., microengines of a network processor. In additional embodiments, the debugger may monitor put and get operations to queue messages unrelated to packet processing. For instance, the described message monitoring operations may be used to monitor the execution of instructions to pass any type of messages between different processors in a multi-processor environment. In certain embodiments, the processors executing the instructions may not comprise packet engines and may comprise different types of processors, including central processing units, Input/Output controllers, storage controllers, video controllers, etc. Alternatively, the described message monitoring operations may be used to monitor message queuing and dequeuing operations with respect to a single processor.

In the described embodiments, a GUI type interface was used to allow the user to monitor the put and get operations. In alternative embodiments, the user may use keyboard commands to select entries from the pipe monitor data 78 and pipe historical data 80 to display source code and message content, as well as set breakpoints and obtain latency information.

FIGS. 5, 6, and 7 illustrate information maintained with pipe debug data, pipe monitor data, and pipe historical data. The data described may be maintained in formats and data structures other than shown in FIGS. 5, 6, and 7. Further additional or different information may be included with the pipe data.

In described embodiments, the source code related to selected put and get operations is generated in the user interface, i.e., displayed. Alternatively, the list file code corresponding to a selected put or get operation may be generated in the user interface.

The list file may comprise compiled or translated file, or flat files, initially coded in programming languages known in the art, including C, assembly language, etc. In yet alternative embodiments, the code from the source file corresponding to the code being executed may be displayed in the debugger user interface, instead of a compiled or translated program, e.g., the list file 34.

In described embodiments, the microcode is executed by packet engines in a simulated execution environment. In alternative embodiments, the debugger program may monitor the execution of the microcode by actual packet engines in a network processor test device.

The term packet was sometimes used in the above description to refer to a packet conforming to a network communication protocol. However, a packet may also be a frame, fragment, ATM cell, and so forth, depending on the network technology being used. Alternatively, a packet may refer to a unit of data transferred from devices other than network devices, such as storage controllers, printer controllers, etc. In such alternative implementations, the key from the header for such alternative packets may include information that is not related to the transmission of a packet over a network.

Preferably, the threads are implemented in computer programs such as a high level procedural or object oriented programming language. However, the program(s) can be implemented in assembly or machine language if desired. The language may be compiled or interpreted. Additionally, these techniques may be used in a wide variety of networking environments.

The illustrated operations of FIGS. 8, 9, 10, 11, and 12 show certain events occurring in a certain order. In alternative embodiments, certain operations may be performed in a different order, modified or removed. Moreover, operations may be added to the above described logic and still conform to the described embodiments.

Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit the embodiments to the precise form disclosed. Many modifications and variations are possible in light of the above teaching.

1. A method, comprising:
monitoring execution of an operation to add a message to a queue;
accessing debug information for the operation indicating a program counter of the instruction and a message address of the message in the queue; and
generating monitor data for the operation including the accessed debug information and message content at the message address in the debug information.

2. The method of claim 1, wherein the generated monitor data further includes an execution cycle indicating a cycle on which the operation was executed.

3. The method of claim 1, wherein the debug information includes a format of the message, further comprising:
using the format information to format the message content, wherein the monitor data includes the formatted message content.

4. The method of claim 1, wherein monitoring the execution of the operation comprises:
determining a program counter of the operation; and
searching for debug information having a program counter matching the determined program counter of the operation, wherein the accessed debug information includes the program counter matching the operation program counter.

5. The method of claim 1, wherein the operation comprises a put operation, further comprising:
receiving a get operation to process one message in the queue;
determining the monitor data for the put operation that added the message to the queue that the received get operation processes; and
generating historical data including a get program counter for the get operation, the put program counter in the monitor data for the put operation, and the message content.

6. The method of claim 5, wherein generating the historical data further comprises:
determining debug information for the received get operation having a program counter matching the program counter of the get operation, wherein the get program counter is determined from the debug information.

7. The method of claim 5, wherein the historical data indicates a first processor executing the put operation and a second processor executing the get operation.

8. The method of claim 5, further comprising:
generating a list of historical data entries, wherein each entry comprises historical data for one put and get operation pair;
receiving user selection of one historical data entry instruction in the list;
determining source code associated with one of the get program counter or put program counter in the selected historical data entry; and
generating the determined source code.

9. The method of claim 5, wherein the historical data includes a put cycle in which the put operation is executed and a get cycle in which the get operation is executed, comprising:
determining a difference between the put cycle and get cycle; and
generating information on the determined difference.

10. The method of claim 1, wherein the operation comprises a put operation, further comprising:
generating a list of historical data entries, wherein each entry comprises historical data for one put operation that added one message to the queue and one get operation that accessed the added message from the queue;
receiving user selection of one historical data entry instruction in the list; and
generating the message content included with the selected historical data entry.

11. The method of claim 1, further comprising:
generating a list of operations having monitor data entries;
receiving user selection of one operation in the list;
determining source code associated with the program counter in the monitor data entry for the selected operation; and
generating the determined source code.

12. The method of claim 1, further comprising:
generating a list of operations having monitor data entries;
receiving user selection of one operation in the list; and
generating the message content included with the monitor data for the selected operation.

13. The method of claim 1, wherein the operation comprises a put operation, further comprising:
receiving selection of a breakpoint with respect to one get operation having monitor data, wherein the get operation accesses one message from the queue added by one put operation;
determining execution of one get operation to the message address having a message added by the put operation for which the breakpoint was set; and
stopping execution of the determined get operation.

14. The method of claim 1, wherein the operation comprises a first operation, wherein the message is transmitted between a first and second packet engines in a network processor, wherein the first packet engine executes the first operation to add the message to the queue, and wherein the second packet engine executes a second operation to process the message in the queue.

15. The method of claim 14, wherein the first and second packet engines are implemented in a simulator in which first and second packet engine operations are simulated.

16. A system, comprising:
a memory;
circuitry enabled to:
(i) monitor execution of an operation to add a message to a queue in the memory;
(ii) access debug information for the operation indicating a program counter of the instruction and a message address of the message in the queue; and
(iii) generate monitor data for the operation including the accessed debug information and the message content at the message address in the debug information.

17. The system of claim 16, wherein the generated monitor data further includes an execution cycle indicating a cycle on which the operation was executed.

18. The system of claim 16, wherein the debug information includes a format of the message, wherein the circuitry is further enabled to:
use the format information to format the message content, wherein the monitor data includes the formatted message content.

19. The system of claim 16, wherein monitoring the execution of the operation comprises:
determining a program counter of the operation; and
searching for debug information having a program counter matching the determined program counter of the operation, wherein the accessed debug information includes the program counter matching the operation program counter.

20. The system of claim 16, wherein the operation comprises a put operation, wherein the circuitry is further enabled to:
receive a get operation to process one message in the queue;
determine the monitor data for the put operation that added the message to the queue that the received get operation processes; and
generate historical data including a get program counter for the get operation, the put program counter in the monitor data for the put operation, and the message content.

21. The system of claim 20, wherein generating the historical data further comprises:
determining debug information for the received get operation having a program counter matching the program counter of the get operation, wherein the get program counter is determined from the debug information.

22. The system of claim 20, wherein the historical data indicates a first processor executing the put operation and a second processor executing the get operation.

23. The system of claim 20, wherein the circuitry is further enabled to:
generate a list of historical data entries, wherein each entry comprises historical data for one put and get operation pair;
receive user selection of one historical data entry instruction in the list;
determine source code associated with one of the get program counter or put program counter in the selected historical data entry; and
generate the determined source code.

24. The system of claim 20, wherein the historical data includes a put cycle in which the put operation is executed and a get cycle in which the get operation is executed, wherein the circuitry is further enabled to:
determine a difference between the put cycle and get cycle; and
generate information on the determined difference.

25. The system of claim 16, wherein the operation comprises a put operation, and wherein the circuitry is further enabled to:
generate a list of historical data entries, wherein each entry comprises historical data for one put operation that added one message to the queue and one get operation that accessed the added message from the queue;
receive user selection of one historical data entry instruction in the list;
generate the message content included with the selected historical data entry.

26. The system of claim 16, wherein the circuitry is further enabled to:
generate a list of operations having monitor data entries;
receive user selection of one operation in the list;
determine source code associated with the program counter in the monitor data entry for the selected operation; and
generate the determined source code.

27. The system of claim 16, wherein the circuitry is further enabled to:
generate a list of operations having monitor data entries;
receive user selection of one operation in the list; and
generate the message content included with the monitor data for the selected operation.

28. The system of claim 16, wherein the operation comprises a put operation, wherein the circuitry is further enabled to:
receive selection of a breakpoint with respect to one get operation having monitor data, wherein the get operation accesses one message from the queue added by one put operation;
determine execution of one get operation to the message address having a message added by the put operation for which the breakpoint was set; and
stop execution of the determined get operation.

29. The system of claim 16, wherein the operation comprises a first operations, wherein the system comprises a network processor, further comprising:
a first packet engine;
a second packet engine, wherein the message is transmitted between the first and second packet engines, wherein the first packet engine executes the first operation to add the message to the queue, and wherein the second packet engine executes a second operation to process the message in the queue.

30. The system of claim 29, further comprising:
a simulator, wherein the first and second packet engines are implemented in the simulator in which first and second packet engine operations are simulated.

31. An article of manufacture enabled to cause actions to be performed, the actions comprising:
monitoring execution of an operation to add a message to a queue;
accessing debug information for the operation indicating a program counter of the instruction and a message address of the message in the queue; and
generating monitor data for the operation including the accessed debug information and the message content at the message address in the debug information.

32. The article of manufacture of claim 31, wherein the generated monitor data further includes an execution cycle indicating a cycle on which the operation was executed.

33. The article of manufacture of claim 31, wherein the debug information includes a format of the message, wherein the actions further comprise:
using the format information to format the message content, wherein the monitor data includes the formatted message content.

34. The article of manufacture of claim 31, wherein monitoring the execution of the operation comprises:
determining a program counter of the operation; and
searching for debug information having a program counter matching the determined program counter of the operation, wherein the accessed debug information includes the program counter matching the operation program counter.

35. The article of manufacture of claim 31, wherein the operation comprises a put operation, and wherein the actions further comprise:
receiving a get operation to process one message in the queue;
determining the monitor data for the put operation that added the message to the queue that the received get operation processes; and
generating historical data including a get program counter for the get operation, the put program counter in the monitor data for the put operation, and the message content.

36. The article of manufacture of claim 35, wherein generating the historical data further comprises:
determining debug information for the received get operation having a program counter matching the program counter of the get operation, wherein the get program counter is determined from the debug information.

37. The article of manufacture of claim 35, wherein the historical data indicates a first processor executing the put operation and a second processor executing the get operation.

38. The article of manufacture of claim 35, wherein the actions further comprise:
generating a list of historical data entries, wherein each entry comprises historical data for one put and get operation pair;
receiving user selection of one historical data entry instruction in the list;
determining source code associated with one of the get program counter or put program counter in the selected historical data entry; and
generating the determined source code.

39. The article of manufacture of claim 35, wherein the historical data includes a put cycle in which the put operation is executed and a get cycle in which the get operation is executed, comprising:
determining a difference between the put cycle and get cycle; and
generating information on the determined difference.

40. The article of manufacture of claim 31, wherein the operation comprises a put operation, wherein the actions further comprise:
generating a list of historical data entries, wherein each entry comprises historical data for one put operation that added one message to the queue and one get operation that accessed the added message from the queue;
receiving user selection of one historical data entry instruction in the list;
generating the message content included with the selected historical data entry.

41. The article of manufacture of claim 31, wherein the actions further comprise:
generating a list of operations having monitor data entries;
receiving user selection of one operation in the list;
determining source code associated with the program counter in the monitor data entry for the selected operation; and
generating the determined source code.

42. The article of manufacture of claim 31, wherein the actions further comprise:
generating a list of operations having monitor data entries;
receiving user selection of one operation in the list; and
generating the message content included with the monitor data for the selected operation.

43. The article of manufacture of claim 31, wherein the operation comprises a put operation, and wherein the actions further comprise:
receiving selection of a breakpoint with respect to one put operation having monitor data, wherein the get operation accesses one message from the queue added by one put operation;
determining execution of one get operation to the message address having a message added by the put operation for which the breakpoint was set; and
stopping execution of the determined get operation.

44. The article of manufacture of claim 31, wherein the operation comprises a first operation, wherein the message is transmitted between a first and second packet engines in a network processor, wherein the first packet engine executes the first operation to add the message to the queue, and wherein the second packet engine executes a second operation to process the message in the queue.
